(19) United States
(12) Patent Application Publication
(10) Pub. No.: US 2017/0141457 A1
(43) Pub. Date: May 18, 2017

(54) ANTENNA DEVICE AND WIRELESS DEVICE

(71) Applicant: KABUSHIKI KAISHA TOSHIBA, Tokyo (JP)

(72) Inventors: Takafumi OHISHI, Yokohama Kanagawa (JP); Kazuhiro INOUE, Inagi Tokyo (JP)

(73) Assignee: KABUSHIKI KAISHA TOSHIBA, Tokyo (JP)

(21) Appl. No.: 15/417,494

(22) Filed: Jan. 27, 2017

Related U.S. Application Data
(63) Continuation of application No. PCT/JP2015/051704, filed on Jan. 22, 2015.

(51) Int. Cl. H01Q 1/24; H01Q 7/00; H01Q 1/38; H01Q 1/48

(52) U.S. Cl. CPC H01Q 1/24; H01Q 1/48; H01Q 7/00; H01Q 1/38

(57) ABSTRACT

An antenna device includes a substrate, and a linear conductive element disposed on the substrate, the linear conductive element having a loop shape in line symmetry with respect to a first straight line and a second straight line perpendicular to the first straight line, respectively, an electrical length between intersection points of the linear conductive element and the first straight line is an integer multiple of a wavelength in a resonance frequency.

### CROSS-REFERENCE TO RELATED APPLICATIONS

This application is a continuation of PCT international application Ser. No. PCT/JP2015/051704 filed on Jan. 22, 2015, which designates the United States; the entire contents of which are incorporated herein by reference.

### FIELD

Embodiments of the present invention relate to an antenna device and a wireless device.

### BACKGROUND

There has been a known antenna in which a loop-shaped antenna element is disposed at a short distance from a ground plane. When a boundary length of the loop-shaped antenna element is set to be less than or equal to about one wavelength, a direction of directivity of the antenna is perpendicular to the ground plane.

However, a conventional antenna does not consider directivity of a direction parallel to the ground plane, and may not communicate with a wireless device disposed parallel to the ground plane. As described above, the conventional antenna has a problem that communication in the direction parallel to the ground plane is restricted.

### BRIEF DESCRIPTION OF DRAWINGS

FIG. 1 is a perspective view illustrating an antenna device according to a first embodiment.

FIG. 2 is a top view illustrating the antenna device according to the first embodiment.

FIG. 3 is a diagram illustrating an emission characteristic of the antenna device according to the first embodiment.

FIG. 4 is a diagram for description of the emission characteristic of the antenna device according to the first embodiment.

FIG. 5 is a diagram illustrating the emission characteristic of the antenna device according to the first embodiment.

FIG. 6 is a diagram illustrating an antenna device according to Modified Example 1 of the first embodiment.

FIG. 7 is a diagram illustrating an antenna device according to Modified Example 2 of the first embodiment.

FIG. 8 is a top view illustrating an antenna device according to a second embodiment.

FIG. 9 is a diagram illustrating an emission characteristic of the antenna device according to the second embodiment.

FIG. 10 is a diagram illustrating a wireless device according to a third embodiment.

FIG. 11 is a diagram illustrating the wireless device according to the third embodiment.

FIG. 12 is a diagram illustrating a wireless device according to Modified Example 3 of the third embodiment.

FIG. 13 is a diagram illustrating a wireless device according to Modified Example 4 of the third embodiment.

### DETAILED DESCRIPTION

According to an embodiment, an antenna device includes a substrate and a linear conductive element. The linear conductive element disposes on the substrate. The linear conductive element has a loop shape in line symmetry with respect to a first straight line and a second straight line perpendicular to the first straight line, respectively, an electrical length between intersection points of the linear conductive element and the first straight line is an integer multiple of a wavelength in a resonance frequency.

### First Embodiment

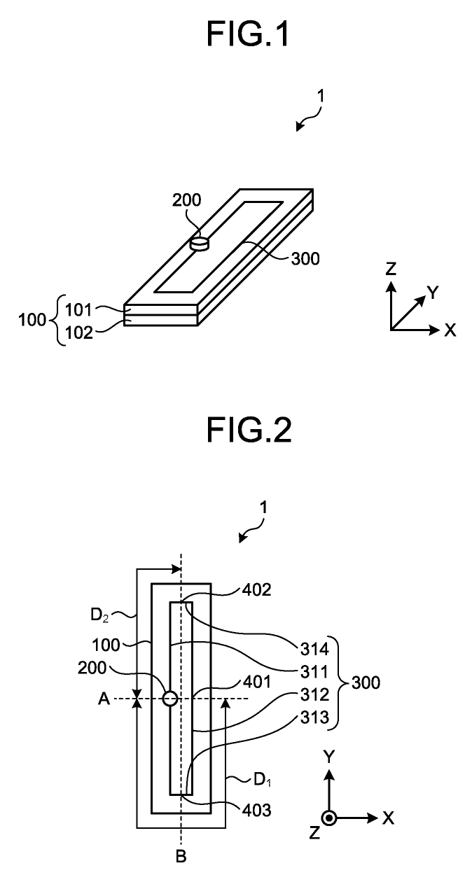

FIG. 1 is a perspective view illustrating a configuration of an antenna device 1 according to a first embodiment. For facilitate understanding of the invention, FIG. 1 illustrates a three-dimensional (3D) Cartesian coordinate system including a Z axis whose positive direction is directed upward in the figure and whose negative direction is directed downward in the figure. Such a Cartesian coordinate system may be illustrated in another figure used for a description below.

The antenna device 1 includes a substrate 100, a feeding point 200, and a linear conductive element 300. The substrate 100 is a multi-layer substrate including a rectangular dielectric layer 101 and a ground layer 102. For example, the ground layer 102 is configured as a metal layer of copper, gold, etc.

The linear conductive element 300 is a loop-shaped antenna element disposed on the dielectric layer 101 of the substrate 100. The feeding point 200 is provided on the linear conductive element 300. The linear conductive element 300 transmits a signal input from a wireless unit (not illustrated) through the feeding point 200. Alternatively, the linear conductive element 300 outputs a received signal to the wireless unit through the feeding point 200.

Next, details of the linear conductive element 300 will be described using FIG. 2. FIG. 2 is a top view illustrating the antenna device 1 according to the present embodiment. The linear conductive element 300 illustrated in FIG. 2 has a loop shape which is in line symmetry with respect to a first straight line A and a second straight line B orthogonal to the first straight line A. Herein, the first and second straight lines A and B are virtual straight lines parallel to the substrate 100. In other words, the substrate 100 has a surface parallel to a surface including the first and second straight lines A and B, and the linear conductive element 300 is provided on the surface.

The linear conductive element 300 includes a first linear element 311 in which the feeding point 200 is provided, and a second linear element 312 parallel to the first linear element 311. The first and second linear elements 311 and 312 are in line symmetry with respect to the second straight line B, and parallel to the second straight line B.

In addition, the linear conductive element 300 includes a third linear element 313 having one end connected to one end of the first linear element 311 and the other hand connected to one end of the second linear element 312, and a fourth linear element 314 having one end connected to the other end of the first linear element 311 and the other end connected to the other end of the second linear element 312. The third and fourth linear elements 313 and 314 are in line symmetry with respect to the first straight line A, and parallel to the first straight line A.

Therefore, as illustrated in FIG. 2, the linear conductive element 300 has a rectangular shape. In addition, the feeding point 200 is provided at a center of a long side of the linear conductive element 300, and the first straight line A passes through the feeding point 200.

In FIG. 2, the feeding point 200 is provided at an intersection point of the linear conductive element 300 and the first straight line A. However, the invention is not restricted thereto. The feeding point 200 may be provided in an arbitrary place when the feeding point 200 is provided on the loop-shaped linear conductive element 300.

In the linear conductive element 300, an electrical length between intersection points of the linear conductive element 300 and the first straight line A is an integer multiple of a wavelength λ in a resonance frequency f. In more detail, an electrical length D₁ of the linear conductive element 300 from the feeding point 200 corresponding to a first intersection point of the linear conductive element 300 and the first straight line A to a second intersection point of the linear conductive element 300 and the first straight line A (hereinafter referred to as an intersection point 401) is set to a length satisfying an equation of 2πD₁/λ+π=(2n−1)×n. Herein, n is an integer greater than or equal to 2.

In this way, the electrical length D₁ of the linear conductive element 300 corresponds to an integer multiple of the wavelength λ in the resonance frequency f of the linear conductive element 300 (D₁=(n−1)λ, n: a natural number greater than or equal to 2). Since the linear conductive element 300 has a loop shape which is in line symmetry with respect to the first straight line A, a boundary length D of the linear conductive element 300 is twice as long as the electrical length D₁ of the linear conductive element 300 (D=2D₁=2(n−1)λ).

Next, a description will be given of an operation principle of the antenna device 1 using FIG. 2. A current input through the feeding point 200 flows to the linear conductive element 300. Since the electrical length D₁ from the feeding point 200 of the linear conductive element 300 to the intersection point 401 is an integer multiple of the wavelength λ in the resonance frequency f as described above, a direction of a current flowing through the feeding point 200 is reverse to a direction of a current flowing through the intersection point 401 in FIG. 2. In other words, currents flowing through the respective first and second linear elements 311 and 312 correspond to reverse phases in FIG. 2.

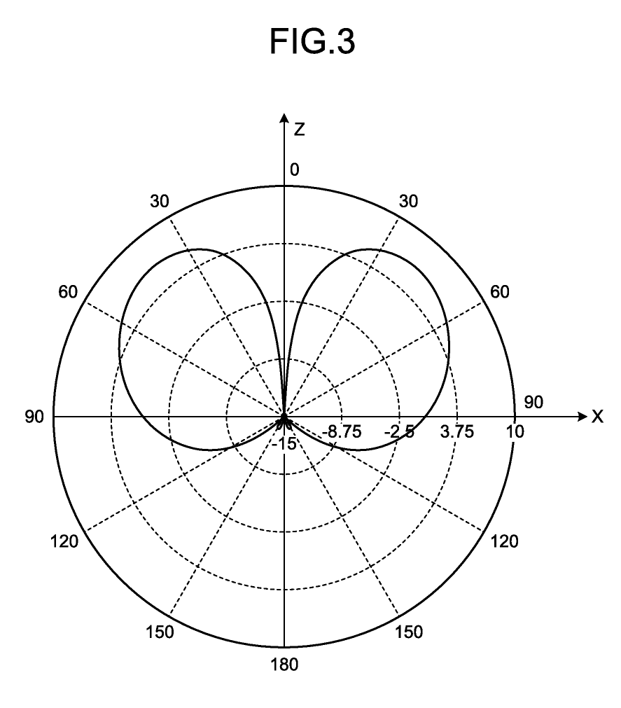

For this reason, emissions by the currents flowing through the respective first and second linear elements 311 and 312 cancel out each other. Therefore, emission in a direction from the substrate 100 to the linear conductive element 300 (positive direction in the Z axis in FIGS. 1 and 2) is suppressed, and excellent emission is obtained in a direction parallel to the substrate 100 (directions of X and Y axes in FIGS. 1 and 2) (see FIG. 3).

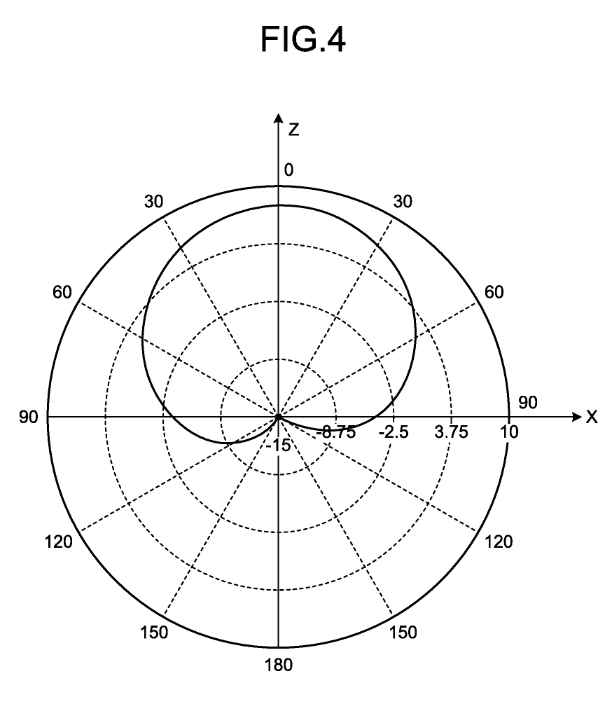

FIG. 3 is a diagram illustrating an emission characteristic of the antenna device 1 according to the present embodiment. FIG. 4 is a diagram for description of an emission characteristic when a whole length of the linear conductive element 300 is set to one wavelength as a comparative example. FIG. 4 is a diagram illustrating an emission characteristic of the antenna device 1 in which an electrical length corresponding to the electrical length D₁ of the linear conductive element 300 is a half wavelength.

As illustrated in FIG. 3, the antenna device 1 according to the present embodiment has an emission characteristic in which emission in the positive direction in the Z axis is suppressed, and excellent emission is obtained in the X axis direction.

Meanwhile, in the case of the antenna device 1 illustrated in FIG. 4, an electrical length corresponding to the electrical length D₁ of the linear conductive element 300 is an integer multiple of a half wavelength, and thus currents flowing through the respective first and second linear elements 311 and 312 of the linear conductive element 300 correspond to the same phase. For this reason, emissions by the currents flowing through the respective first and second linear elements 311 and 312 intensify each other. Therefore, in an emission characteristic of the antenna device 1, as illustrated in FIG. 4, excellent emission is obtained in the positive direction in the Z axis, and emission in the X axis direction is suppressed.

In the emission characteristic of the antenna device 1 of the present embodiment illustrated in FIG. 3, emission in the direction from the substrate 100 to the linear conductive element 300 (Z axis direction) is suppressed, and emission in the direction (X axis direction) parallel to the substrate 100 is improved when compared to FIG. 4. When FIG. 3 and FIG. 4 are compared, emission in the direction (X axis direction) parallel to the substrate 100 is improved by about 7 dB by the antenna device 1 of the present embodiment.

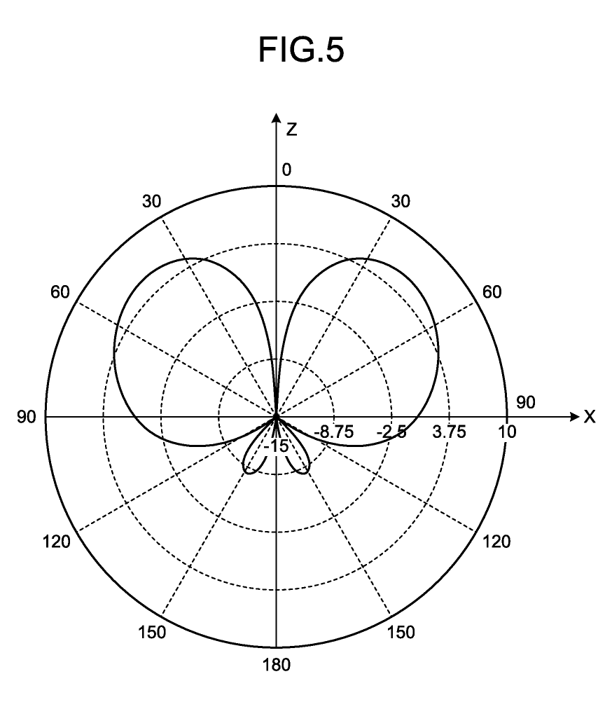

Next, a description will be given of another example of the emission characteristic of the antenna device 1 according to the present embodiment using FIG. 5. FIG. 5 is a diagram illustrating an emission characteristic when a rectangular parallelepiped phantom (not illustrated) is disposed near the substrate 100 side of the antenna device 1 according to the present embodiment. In the example illustrated in FIG. 5, an emission characteristic of the antenna device 1 is illustrated when the rectangular parallelepiped phantom is disposed at a position separated from the ground layer of the antenna device 1 by about 10 mm.

As illustrated in FIG. 5, in the emission characteristic of the antenna device 1, emission in the direction from the substrate 100 to the linear conductive element 300 (positive direction in the Z axis), and excellent emission is obtained in the direction (X axis direction) parallel to the substrate 100 similarly to FIG. 3. In addition, emission in a direction from the linear conductive element 300 to the substrate 100 (negative direction in the Z axis) is suppressed. Therefore, for example, even when a human body is disposed on the substrate 100 side, the antenna device 1 is rarely affected by the human body.

As described in the foregoing, in the antenna device 1 according to the present embodiment, the linear conductive element 300 has the loop shape which is in line symmetry with respect to the first and second straight lines A and B, and the electrical length D₁ of the linear conductive element 300 is set to an integer multiple of one wavelength. In this way, it is possible to suppress emission in the direction from the substrate 100 to the linear conductive element 300, and to increase emission in the direction parallel to the substrate 100. Therefore, for example, the antenna device 1 may communicate with a wireless device disposed in a direction parallel to the substrate 100, and a degree of freedom of communication may be improved.

The antenna device 1 according to the present embodiment may increase emission in the direction parallel to the substrate 100 as described above. For this reason, for example, the antenna device 1 is suitable for On-body communication in which wireless devices installed in the human body communicate with each other, a case in which wireless devices installed on a surface of a structure on a wall, etc. communicate with each other, etc.

### Modified Example 1

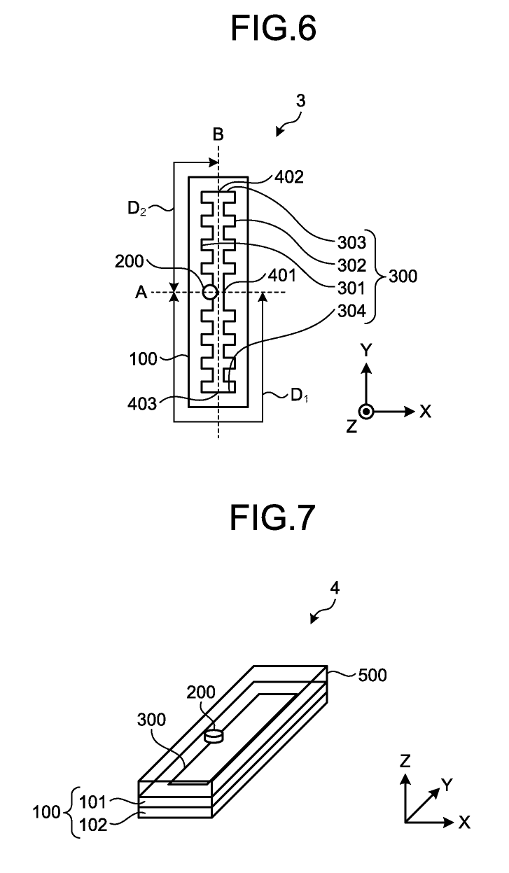

FIG. 6 is a diagram illustrating an antenna device 3 according to Modified Example 1 of the present embodiment. The antenna device 3 has the same configuration as that of the antenna device 1 according to the first embodiment except that at least a portion of a linear conductive element 300 has a meander shape.

The linear conductive element 300 of the antenna device 3 includes first to fourth linear elements 301 to 304. The first linear element 301 has a meander shape, and a feeding point 200 is provided on the first linear element 301. The second linear element 302 has a meander shape, and the first linear element 301 and the second linear element 302 are in line symmetry with respect to a second straight line B.

The third linear element 303 has a straight line shape in which one end is connected to one end of the first linear element 301 and the other end is connected to one end of the second linear element 302. In addition, the fourth linear element 304 has a straight line shape in which one end is connected to the other end of the first linear element 301 and the other end is connected to the other end of the second linear element 302. The third and fourth linear elements 303 and 304 are in line symmetry with respect to a first straight line A.

In the antenna device 3 according to the present modified example, a physical length of the linear conductive element 300 may be set to be short while an electrical length D₁ of the linear conductive element 300 is set to an integer multiple of one wavelength, and the linear conductive element 300 may be miniaturized by forming the first and second linear elements 301 and 302 in meander shapes. Therefore, the antenna device 3 according to the present modified example may be miniaturized.

Even though the first and second linear elements 301 and 302 are formed in the meander shapes in the present modified example, the third and fourth linear elements 303 and 304 may be formed in meander shapes. In addition, at least some of linear conductive elements of an antenna device according to another embodiment described below may be formed in meander shapes.

### Modified Example 2

FIG. 7 is a diagram illustrating an antenna device 4 according to Modified Example 2 of the present embodiment. In addition to respective components of the antenna device 1 according to the first embodiment, the antenna device 4 further includes a second dielectric layer 500.

The second dielectric layer 500 is disposed on an opposite side from a substrate 100 of a linear conductive element 300. In other words, the linear conductive element 300 is formed between a dielectric layer 101 and the second dielectric layer 500. In this way, when the linear conductive element 300 is formed between the dielectric layer 101 and the second dielectric layer 500, a wavelength of a radio wave emitted from the linear conductive element 300 and propagated to the second dielectric layer 500 is shortened depending on a dielectric constant of the second dielectric layer 500. For this reason, a physical length of the linear conductive element 300 may be shortened while an electrical length D₁ of the linear conductive element 300 is set to an integer multiple of one wavelength, and the linear conductive element 300 may be miniaturized. Therefore, the antenna device 4 according to the present modified example may be miniaturized.

The second dielectric layer 500 may be further included in addition to respective component of an antenna device according to another embodiment described below.

### Second Embodiment

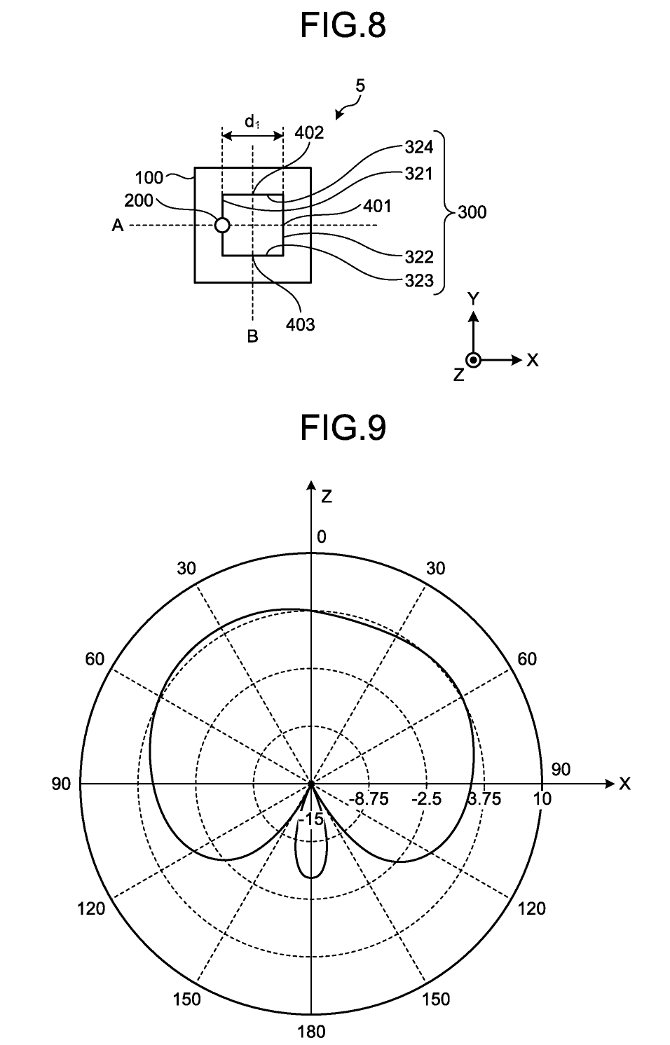

FIG. 8 is a top view illustrating a configuration of an antenna device 5 according to a second embodiment. The antenna device 5 according to the present embodiment has the same configuration as that of the antenna device 1 according to the first embodiment except for configurations of first to fourth linear elements 321 to 324 included in a linear conductive element 300. Therefore, the same reference numeral will be assigned to the same component as that of the antenna device 1 according to the first embodiment, and a description thereof will be omitted.

The linear conductive element 300 of the antenna device 5 illustrated in FIG. 8 includes the first and second linear elements 321 and 322 parallel to each other. An electrical length between the first and second linear elements 321 and 322 is an odd multiple of a half wavelength of a resonance frequency f ((2m−1)λ/2, m: natural number). Other configurations are the same as those of the antenna device 1 illustrated in FIG. 1.

In addition, the linear conductive element 300 includes the third linear element 323 having one end connected to one end of the first linear element 321 and the other end connected to one end of the second linear element 322, and the fourth linear element 324 having one end connected to the other end of the first linear element 321 and the other end connected to the other end of the second linear element 322. The third and fourth linear elements 323 and 324 are in line symmetry with respect to a first straight line A.

As described above, an electrical length d₁ between the first linear element 321 and the second linear element 322 is set to an odd multiple of the half wavelength of the resonance frequency f ((2m−1)λ/2), that is, a length satisfying an equation of 2πd₁/λ=(2m−1)×π. In FIG. 8, it is presumed that n=2, and m=1, that is, an electrical length D₁ of the linear conductive element 300 is one wavelength, and the electrical length d₁ is a half wavelength.

In this case, the linear conductive element 300 has a square shape, and the electrical length d₁ between the first and second linear elements 321 and 322 is equal to an electrical length of each of the third and fourth linear elements 323 and 324. In addition, an electrical length between the third and fourth linear elements 323 and 324 is equal to an electrical length of each of the first and second linear elements 321 and 322.

Next, a description will be given of an operation principle of the antenna device 5. A current input through a feeding point 200 flows to the linear conductive element 300. As described in the first embodiment, an electrical length D₁ from the feeding point 200 of the linear conductive element 300 to an intersection point 401 is an integer multiple of a wavelength λ in a resonance frequency f, and thus directions of currents flowing to the first and second linear elements 321 and 322 are reverse to each other.

Herein, in the antenna device 5 according to the present embodiment, the electrical length d₁ between the first and second linear elements 321 and 322 is set to the half wavelength of the resonance frequency f. In this way, emission in an X axis direction of FIG. 8 is improved. In addition, since the electrical length between the third and fourth linear elements 323 and 324 is a half wavelength of a resonance frequency f, emission in a Y axis direction of FIG. 8 is improved.

A reason therefor is that the electrical length d₁ between the first and second linear elements 321 and 322 is the half wavelength of the resonance frequency f, and thus, for example, a phase of a radio wave emitted by a current flowing to the first linear element 321 is advanced by an odd multiple of the half wavelength until the radio wave arrives at the second linear element 322. Therefore, a phase of a radio wave emitted from the first linear element 321 and a phase of a radio wave emitted from the second linear element 322 correspond to the same phase in the second linear element 322.

Similarly, a phase of a radio wave emitted by a current flowing to the second linear element 322 is advanced by an odd multiple of the half wavelength until the radio wave arrives at the first linear element 321. Therefore, a phase of a radio wave emitted from the second linear element 322 and a phase of a radio wave emitted from the first linear element 321 correspond to the same phase in the first linear element 321.

In this way, emission by the current flowing to the first linear element 321 and emission by the current flowing to the second linear element 322 are canceled out in the X axis direction. Therefore, the antenna device 5 may obtain more excellent emission in a direction parallel to a substrate 100 (X axis direction of FIG. 8). Emissions by the currents flowing to the third and fourth linear elements 323 and 324 are canceled out in the Y axis direction for a similar reason, and the antenna device 5 may obtain more excellent emission in a direction parallel to the substrate 100 (Y axis direction of FIG. 8).

FIG. 9 is a diagram illustrating an emission characteristic of the antenna device 5. As illustrated in FIG. 9, the antenna device 5 may obtain more excellent emission in a direction parallel to the substrate 100 (X axis direction of FIG. 9) when compared to the emission characteristic of the antenna device 1 illustrated in FIG. 3. In the emission characteristic of the antenna device 5 illustrated in FIG. 9, excellent emission is obtained in a direction from the substrate 100 to the linear conductive element 300 (positive direction in a Z axis of FIG. 9). A reason therefor is considered that electrical lengths of the third and fourth linear elements 323 and 324 in the antenna device 5 according to the present embodiment are set to be longer than those of the antenna device 1 described in the first embodiment. It is considered that since the electrical lengths of the third and fourth linear elements 323 and 324 are long, more radio waves are emitted from the third and fourth linear elements 323 and 324, and radio waves emitted from the first and second linear elements 321 and 322 are rarely canceled out in a Z axis direction.

As described in the foregoing, the antenna device 5 according to the present embodiment may obtain the same effect as that of the first embodiment. Further, more excellent emission is obtained in the direction parallel to the substrate 100 by setting the electrical length d₁ between the first and second linear elements 321 and 322 to the odd multiple of the half wavelength of the resonance frequency f. In addition, excellent emission may be obtained in the direction from the substrate 100 to the linear conductive element 300 (positive direction in the Z axis of FIG. 8). In this way, for example, the antenna device 5 may communicate with a wireless device disposed in the direction from the substrate 100 to the linear conductive element 300 in addition to a wireless device disposed parallel to the substrate 100, and a degree of freedom of communication may be further improved.

In FIG. 8, a description has been given of a case in which n=2 and m=1, that is, the linear conductive element 300 has the square shape. However, the shape of the linear conductive element 300 is not restricted thereto. The electrical length between the first and second linear elements 321 and 322 or the electrical length between the third and fourth linear elements 323 and 324 may be the odd multiple of the half wavelength, and the linear conductive element 300 may have a rectangular shape.

### Third Embodiment

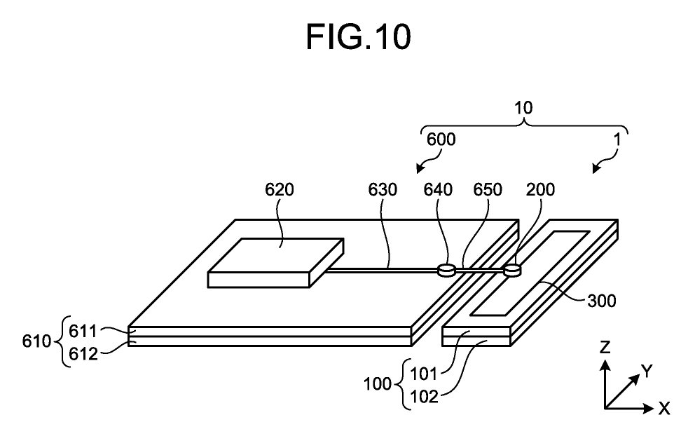

FIG. 10 is a diagram illustrating a wireless device 10 according to a third embodiment. The wireless device 10 according to the present embodiment is mounted with the antenna device 1 illustrated in FIG. 1. However, the wireless device 10 may be mounted with an antenna devices 2 to 5 described in other embodiments and other modified examples.

The wireless device 10 includes the antenna device 1 and a wireless unit 600 that transmits or receives a signal through the antenna device 1. The wireless unit 600 includes a substrate 610, a wireless circuit 620, a signal wire 630, a terminal 640, and a feeder 650.

The substrate 610 includes a dielectric layer 611 and a ground layer 612. The wireless circuit 620 is provided on the dielectric layer 611 of the substrate 610. The wireless circuit 620 generates a signal, and transmits the signal through the antenna device 1. Alternatively, the wireless circuit 620 receives a signal through the antenna device 1. The signal wire 630 is connected to the wireless circuit 620 and the terminal 640. The feeder 650 has one end connected to the terminal 640 and the other end connected to the feeding point 200.

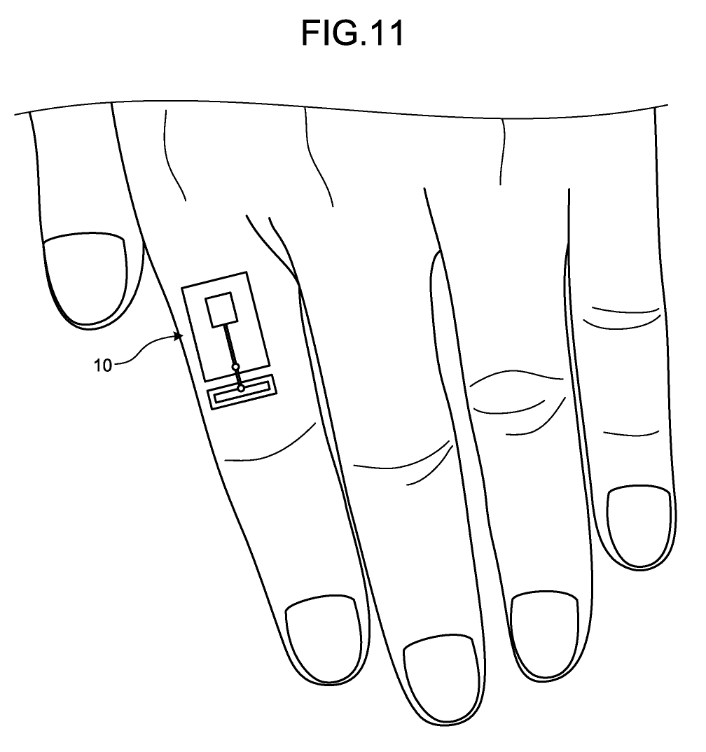

Next, a description will be given of a case in which On-body communication is performed by installing the wireless device 10 on a finger using FIG. 11. For example, the wireless device 10 is mounted on a ring (not illustrated), and the ring is installed on the finger, thereby installing the wireless device 10 on the finger. Alternatively, the wireless device 10 may be installed on the finger using a belt.

A case is considered in which the wireless device 10 installed on the finger communicates with the wireless device 10 installed, for example, on a chest (not illustrated). In the case of On-body communication in which the wireless devices 10 installed on the human body communicate with each other, the wireless devices 10 on substantially the same plane are more likely to communicate with each other when compared to general wireless communication.

The wireless device 10 according to the present embodiment is mounted with the antenna device 1 which is excellent in emission within the same plane as that of the substrate 100, and thus may perform excellent On-body communication even when the wireless device 10 is installed on the human body.

As described above, referring to the wireless device 10 according to the present embodiment, it is possible to obtain the same effect as that of the first embodiment by performing communication through the antenna device 1, and to improve a degree of freedom of communication of the wireless device 10. In addition, the wireless device 10 may perform excellent communication with another wireless device disposed on the same plane when On-body communication is performed by installing the wireless device 10 on the human body.

In the present embodiment, a description has been given of a case in which the antenna device 1 performs transmission and reception. However, the antenna device 1 may perform only transmission or only reception.

In addition, in the present embodiment, a description has been given of a case in which the antenna device 1 and the wireless unit 600 are disposed on the same plane. However, disposition of the antenna device 1 and the wireless unit 600 is not restricted thereto. The antenna device 1 and the wireless unit 600 may be disposed on different planes. In the antenna device 1, emission in a direction perpendicular to the substrate 100 is suppressed, and excellent emission characteristic is obtained in the direction parallel to the substrate 100. Thus, the wireless unit 600 may be disposed in a direction perpendicular to the antenna device 1. In this way, according to the wireless device 10 of the present embodiment, it is possible to improve a degree of freedom of disposition of the antenna device 1.

### Modified Example 3

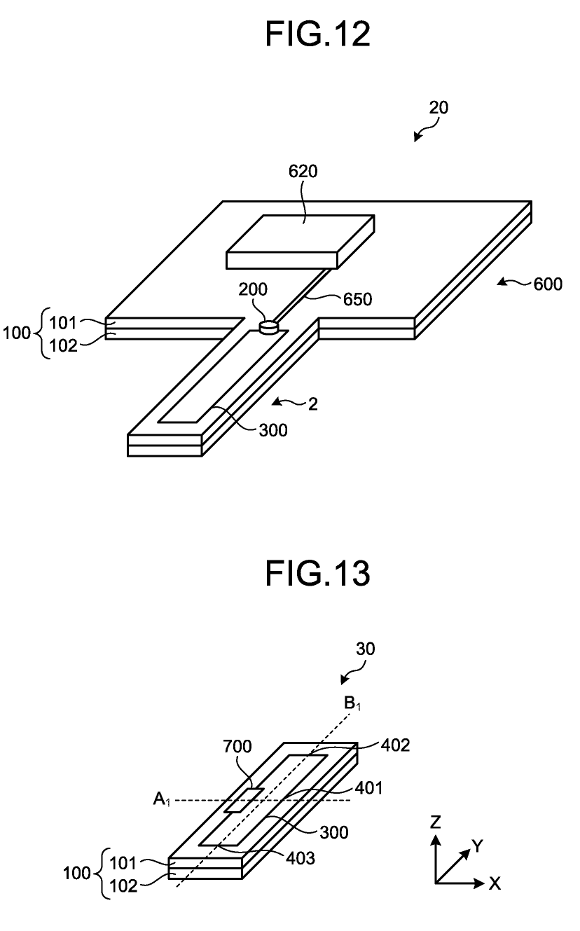

FIG. 12 illustrates a wireless device 20 according to Modified Example 3 of the present embodiment. The wireless device 20 illustrated in FIG. 12 is different from the wireless device 10 of FIG. 10 in that an antenna device 2 is mounted, and a wireless circuit 620 is provided on a substrate 100 of the antenna device 2.

The antenna device 2 has the same configuration as that of the antenna device 1 descried in the first embodiment except that a feeding point 200 is provided at an intersection point 402 of the antenna device 1 illustrated in FIG. 2. In addition, the wireless device 20 does not include the signal wire 630 and the terminal 640, and a feeder 650 of the wireless device 20 has one end connected to the wireless circuit 620 and the other end connected to the feeding point 200.

As described above, the number of components of the wireless device 20 may be reduced by providing the wireless circuit 620 of the wireless device 20 on the substrate 100 of the antenna device 2.

### Modified Example 4

FIG. 13 illustrates a wireless device 30 according to Modified Example 4 of the present embodiment. The wireless device 30 illustrated in FIG. 13 is provided with a wireless unit 700 instead of the feeding point 200. Other components are the same as those of the antenna device 1 illustrated in FIG. 1. Thus, the same reference numerals will be assigned thereto, and a description thereof will be omitted.

For example, the wireless unit 700 corresponds to an integrated circuit (IC) of a radio frequency identifier (RFID) tag, a sensor IC having a radio function, etc. The wireless unit 700 transmits a signal through a linear conductive element 300 by directly inputting the signal to the linear conductive element 300. Alternatively, the wireless unit 700 receives a signal through the linear conductive element 300 by directly receiving the signal from the linear conductive element 300. In this way, the wireless unit 700 operates as the feeding point 200 by directly exchanging a signal with the linear conductive element 300.

The linear conductive element 300 is in line symmetry with respect to a first straight line A₁ passing through the wireless unit 700 and a second straight line B₁ perpendicular to the first straight line A₁. An electrical length D₁ of the linear conductive element 300 from the wireless unit 700 corresponding to an intersection point of the linear conductive element 300 and the first straight line A₁ to an intersection point 401 of the linear conductive element 300 and the first straight line A₁ is an integer multiple of a wavelength λ in a resonance frequency f. In addition, an electrical length D₂ from the wireless unit 700 corresponding to the intersection point of the linear conductive element 300 and the first straight line A₁ to an intersection point 402 of the linear conductive element 300 and the second straight line B₁ is an odd multiple of a half wavelength of the resonance frequency f.

As described above, the antenna devices 1 to 5 of the respective embodiments may be mounted on the wireless device 30 directly connected to an antenna element such as the IC of the RFID tag. In this way, the wireless device 30 may perform communication in a high-angle range, and a degree of freedom of communication is improved.

Even though some embodiments of the invention have been described, these embodiments have been presented as examples, and are not intended to restrict the scope of the invention. These new embodiments may be implemented in various other modes and omitted, replaced, and changed in various manners within a range not departing from a subject matter of the invention. These embodiments or modifications thereof are included in the scope or the subject matter of the invention, and included in the invention described in claims and equivalents thereof.

1. An antenna device comprising:
a substrate; and
a linear conductive element disposed on the substrate, the linear conductive element having a loop shape in line symmetry with respect to a first straight line and a second straight line perpendicular to the first straight line, respectively, an electrical length between intersection points of the linear conductive element and the first straight line is an integer multiple of a wavelength in a resonance frequency.

2. The antenna device according to claim 1, wherein an electrical length from an intersection point of the linear conductive element and the first straight line to an intersection point of the linear conductive element and the second straight line is an odd multiple of a half wavelength of the resonance frequency in the linear conductive element.

3. The antenna device according to claim 1, wherein the first straight line is a straight line passing through a feeding point provided on the linear conductive element.

4. The antenna device according to claim 1,
wherein the linear conductive element includes linear elements parallel to each other, and
an electrical length between the linear elements is an odd multiple of the half wavelength of the resonance frequency.

5. The antenna device according to claim 4, wherein the linear elements are parallel to the second straight line.

6. The antenna device according to claim 4, wherein the linear elements are parallel to the first straight line.

7. The antenna device according to claim 1, wherein the linear conductive element has a rectangular shape.

8. The antenna device according to claim 1, wherein the linear conductive element includes a meander-shaped linear element.

9. The antenna device according to claim 1, further comprising
a dielectric provided on the substrate,
wherein the linear conductive element is provided between the substrate and the dielectric.

10. A wireless device comprising:
an antenna device including
a substrate, and
a linear conductive element disposed on the substrate, the linear conductive element having a loop shape in line symmetry with respect to a first straight line and a second straight line perpendicular to the first straight line, respectively, an electrical length between intersection points of the linear conductive element and the first straight line is an integer multiple of a wavelength in a resonance frequency; and
a wireless unit that performs wireless communication through the antenna device.
